(19) United States
(12) Patent Application Publication
(10) Pub. No.: US 2026/0099616 A1
(43) Pub. Date: Apr. 9, 2026

(54) SYSTEMS AND METHODS FOR DATA ACCESS MANAGEMENT USING ADVANCED COMPUTATIONAL MODELS FOR DATA ANALYSIS AND AUTOMATED PROCESSING

(71) Applicant: BANK OF AMERICA CORPORATION, CHARLOTTE, NC (US)

(72) Inventors: Marshall Adam Johnson, Summit, NJ (US); Manu Jacob Kurian, Dallas, TX (US); Ana Maxim, Arlington, VA (US); Sandra Lynn Dube, Salt Lake City, UT (US); Michael R. Young, Davidson, NC (US)

(73) Assignee: BANK OF AMERICA CORPORATION, CHARLOTTE, NC (US)

(21) Appl. No.: 18/909,237

(22) Filed: Oct. 8, 2024

(51) Int. Cl. G06F 21/62

(52) U.S. Cl. CPC G06F 21/6218

(57) ABSTRACT

Systems, computer program products, and methods are described herein for data access management using advanced computational models for data analysis and automated processing. The present disclosure is configured to receive an interaction, wherein the interaction comprises a transfer of user metadata; analyze, via a custodian artificial intelligence (AI) engine, the interaction, wherein the custodian AI engine is a short-term AI engine configured to manage the interaction; analyze, via a guardian AI engine, the interaction, wherein the guardian AI engine is configured to provide guidelines for the interaction; configure the user metadata based on the custodian AI engine and the guardian AI engine; and cause an execution of the interaction.

### TECHNOLOGICAL FIELD

Example embodiments of the present disclosure relate to systems and methods for data access management using advanced computational models for data analysis and automated processing.

### BACKGROUND

There are significant issues associated with data access management. Applicant has identified a number of deficiencies and problems associated with conventional systems for data access management. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for data access management using advanced computational models for data analysis and automated processing.

Embodiments of the present invention address the above needs and/or achieve other advantages by providing apparatuses (e.g., a system, computer program product, and/or other devices) and methods for data access management using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present disclosure provides for receiving an interaction, wherein the interaction includes a transfer of user metadata. Further, in some embodiments, the present disclosure provides for analyzing, via a custodian AI engine, the interaction, wherein the custodian AI engine is a short-term AI engine configured to manage the interaction. Further, in some embodiments, the present disclosure provides for analyzing, via a guardian AI engine, the interaction, wherein the guardian AI engine is configured to provide guidelines for the interaction. Further, in some embodiments, the present disclosure provides for configuring the user metadata based on the custodian AI engine and the guardian AI engine. Further, in some embodiments, the present disclosure provides for causing an execution of the interaction.

In some embodiments, the present disclosure provides for generating a user persona, wherein the user persona is generated via the user metadata and via historical interactions. In some embodiments, the present disclosure configures the guardian AI engine based on the user persona, wherein the guardian AI engine is configured in real-time based on the user persona and based on the interaction.

In some embodiments, the custodian AI engine managing the interaction includes dynamically configuring an interaction score, wherein the interaction score influences whether the interaction should be executed.

In some embodiments, the guardian AI engine providing guidelines for the interaction includes dynamically configuring an interaction score, wherein the interaction score influences whether the interaction should be executed.

In some embodiments, the interaction score may include a trust score, wherein the trust score includes the ability to trust a party associated with the interaction. In some embodiments, the interaction score may include a usage score, wherein the usage score comprises the party's proposed use of the user metadata. In some embodiments, the interaction score may include a downstream score, wherein the downstream score includes analyzing third parties associated with the party to determine how the user metadata will be used by the third parties.

In some embodiments, the present disclosure may determine an interaction score threshold, wherein the interaction score threshold indicates an allowable interaction score of the interaction. In some embodiments, the present disclosure may determine the interaction score is within the interaction score threshold. In some embodiments, the present disclosure may configure the user metadata prior to transfer during the interaction.

Further, in some embodiments, the present disclosure may determine the interaction score is outside the interaction score threshold. Further, in some embodiments, the present disclosure may obfuscate at least a portion of the user metadata prior to transfer during the interaction.

In some embodiments, the present disclosure may analyze a policy database, wherein the policy database includes rules associated with the interaction. In some embodiments, the present disclosure may configure the guardian AI engine based on the policy database.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for data access management using advanced computational models for data analysis and automated processing, in accordance with an embodiment of the disclosure;

FIG. 2 illustrates an exemplary machine learning (ML) subsystem architecture, in accordance with an embodiment of the disclosure;

FIG. 3 an example process flow for data access management using advanced computational models for data analysis and automated processing, in accordance with an embodiment of the disclosure;

FIG. 4 illustrates an example embodiment for inputs to a guardian artificial intelligence (AI) engine, in accordance with an embodiment of the disclosure; and

FIG. 5 illustrates an example embodiment of a trained guardian AI engine, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “transfer,” a “distribution,” and/or an “allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

As used herein, “metadata” may refer data generated and/or collected about a user's activities, behavior, interactions, or the like with a system or platform. Metadata may provide contextual information used for tracking, analysis, and optimization of user interactions. The metadata may include various attributes such as user identifiers, timestamps, geolocation data, device data, browser details, IP addresses, and the like. Further, metadata may also include network metadata (e.g., the source and/or destination of data packets), application-specific metadata (e.g., the number of API calls made during a session), or the like. For example, metadata associated with an e-commerce platform may track the number of items added to a virtual shopping cart. The metadata may be used for performing real-time analysis and/or optimization processes such as session management, recommendation algorithms, and/or personalized experiences.

Issues often arise in multi-user groups that share a common goal and/or must share common resources to reach the goal, where data must remain secure between the users and the shared resources must remain free from misappropriations. Further, these users have difficulty determining if they are marking the correct decision regarding data transmissions and resource transmissions. Such issues are especially true where important data and/or resources and their transmission can affect multiple resource accounts and secure data for multiple user accounts, and can have long standing effects across generations of users.

The present disclosure as provided herein may provide for a system that generates a short term consortium (e.g., custodian) AI engine and a long term guardian AI engine. As used herein, a short term AI engine may include a consortium AI engine, a custodian AI engine, or the like. In this regard, the short term (e.g., consortium or custodian) AI engine may be spun up, triggered, initialized, provisioned, deployed, invoked, executed, or the like. When the short term AI engine is activated, it may be configured with a smart contract to share trust scores, resources, and/or the like, in the instance where the goal has been met, whereby the secure data may be tokenized to prevent any unsecure publishing of data to untrustworthy users, the resources may be protected by the smart contract, and the goal may be met automatically and efficiently when the conditions are met.

In some embodiments, a user account could be associated with a plurality of consortium AI engines, where each consortium AI engine is configured for each goal, but where any data stored within each consortium AI engine is completely protected and secure from the shared users. Additionally, and in some embodiments, the consortium AI engine may determine the resource amount from each user such that each resource amount is also secure, and data protected. Additionally, and in some embodiments, the system may track each use of the resources as the resources are used by the recipient entity, and/or other such tertiary entities.

The guardian AI engine is trained with many various data points of past and/or current generations of users (such as heads of families, heads of resource accounts, heads of companies and other entities, and/or the like) on how the past or present users would have decided when and/or where to transmit resources and/or secure data. In this manner, the guardian AI engine may generate guidelines or guardrails based on historical data (such as personal historical data of the current and past generation(s) of users, public historical data, and/or the like). Additionally, and in some embodiments, the guardian AI engine may be paired with a digital ledger which is configured to require a certain number of current users and the guardian AI engine to approve an action before allowing the action to be done (e.g., transferring resources, transferring secure data, and/or the like).

Additionally, and in some embodiments, the guardian AI engine may further be trained by a feedback loop of the current users and their actions, the effects of their actions, and/or the like, such that the guardian AI engine can iteratively retrain itself based on current conditions and data points, while maintaining the historical guardrails. Additionally, and in some embodiments, the guardian AI engine may comprise a documentation component which is configured to document each action made, the effects of each action, and other such data to generate a timeline of each event and each event's surrounding data.

The long term guardian AI engine may be trained on personal historical data of current and past users within a group (such as within a company, a family, and/or the like), historical data regarding resource data and/or secure data, and generates guidelines to help current users determine when and/or whether to transmit resources or secure data based on past instances and decisions. In this manner, the guardian AI engine may be trained on multiple generations of data points and knowledge to create guidelines for current and future generations.

What is more, the present disclosure provides a technical solution to a technical problem. As described herein, the technical problem includes ensuring secure and efficient management of resources and sensitive data transfer among multiple users, while preventing unauthorized access or untrustworthy sharing of data. Additionally, managing these transfers across both short-term interactions and long-term decision making based on historical data has posed challenges in terms of trust, accuracy, and resource optimization. The technical solution presented herein allows for the use of a short-term consortium AI engine (or custodian AI engine) combined with a long-term guardian AI engine, where the consortium AI engine manages immediate resource transfers based on smart contract conditions, and the guardian AI engine generates guidelines informed by multi-generational historical data. This provides that the transfers are both secure and contextually informed, while trust scores are dynamically updated to reflect the integrity of the participants. In particular, the use of the consortium AI engine to automatically execute secure transactions upon meeting predefined conditions, and the guardian AI engine's role in providing historically-informed guidelines is an improvement over existing solutions to the, (i) with fewer steps to achieve the solution, thus reducing the amount of computing resources, such as processing resources, storage resources, network resources, and/or the like, that are being used (e.g., by directly invoking the custodian AI engine only when specific conditions are met, the system bypasses redundant checks and manual verification steps that would otherwise require additional computational cycles), (ii) providing a more accurate solution to problem, thus reducing the number of resources required to remedy any errors made due to a less accurate solution (e.g., the guardian AI engine leverages historical data and learned patterns to reduce errors in decision-making for resource transfers, decreasing the likelihood of resource misallocation and minimizing the need for costly corrective actions), (iii) removing manual input and waste from the implementation of the solution, thus improving speed and efficiency of the process and conserving computing resources (e.g., the consortium AI engine automates the entire process of verifying trust scores, triggering transfers, and tracking resource usage, eliminating the need for human oversight and speeding up the process), (iv) determining an optimal amount of resources that need to be used to implement the solution, thus reducing network traffic and load on existing computing resources (e.g., the system assesses the required resource allocation based on historical data from the guardian AI engine, ensuring that only the necessary data and resources are transmitted, thus optimizing the bandwidth and storage usage for each transaction). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the data access management system as described herein is a solution to the problem of secure and efficient resource management and data transfer across multiple users while preventing unauthorized access and misuse. Further, the data access management system may be characterized as identifying a specific improvement in computer capabilities and/or network functionalities in response to the data access management system's integration to existing devices, software, applications, and/or the like. In this way, the data access management system improves the capability of a system to automatically manage resource transfers, enforce security protocols through smart contracts, and optimize decisions based on historical data. Further, the data access management system improves the functionality of networks in response to reducing the resources consumed by the system (e.g., network resources, computing resources, memory resources, and/or the like).

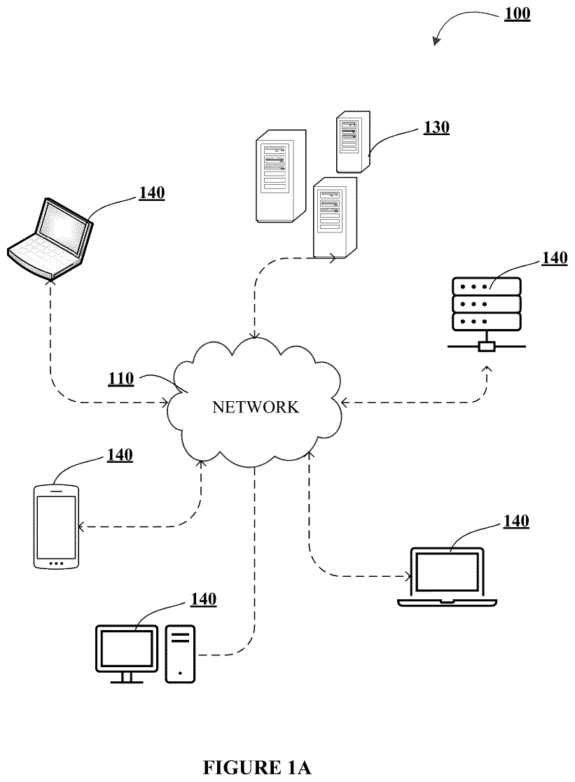

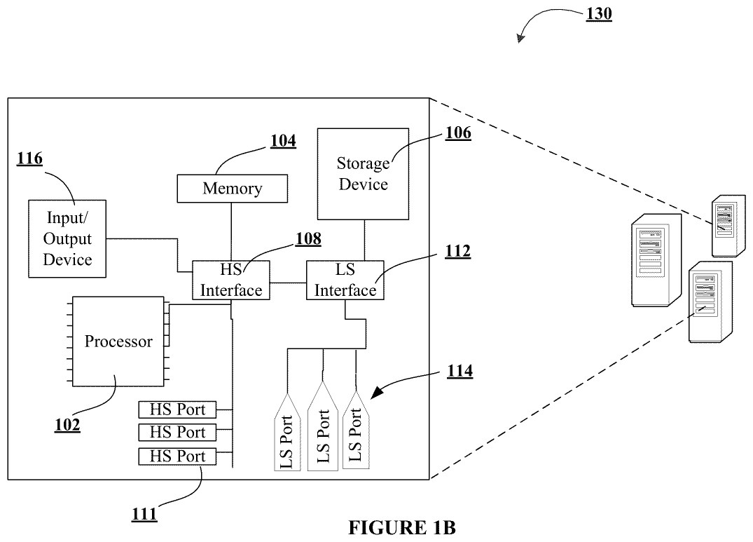

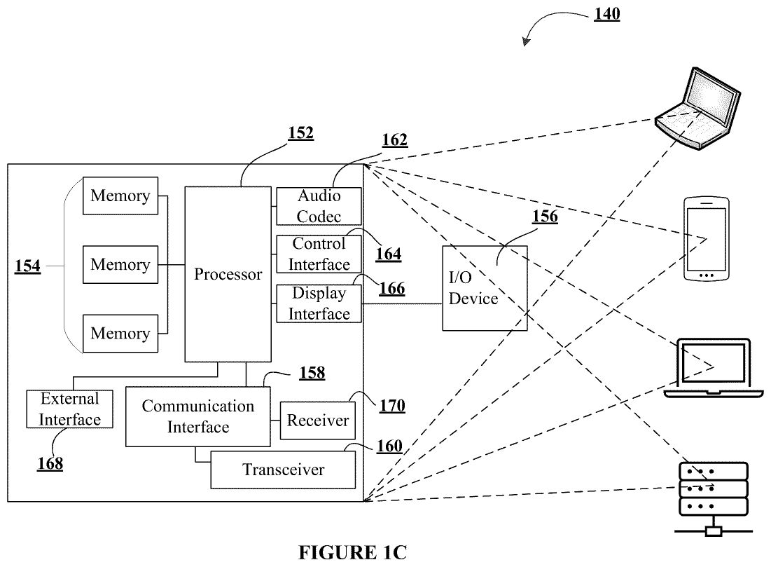

FIGS. 1A-1C illustrate technical components of an exemplary distributed computing environment 100 for data access management using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

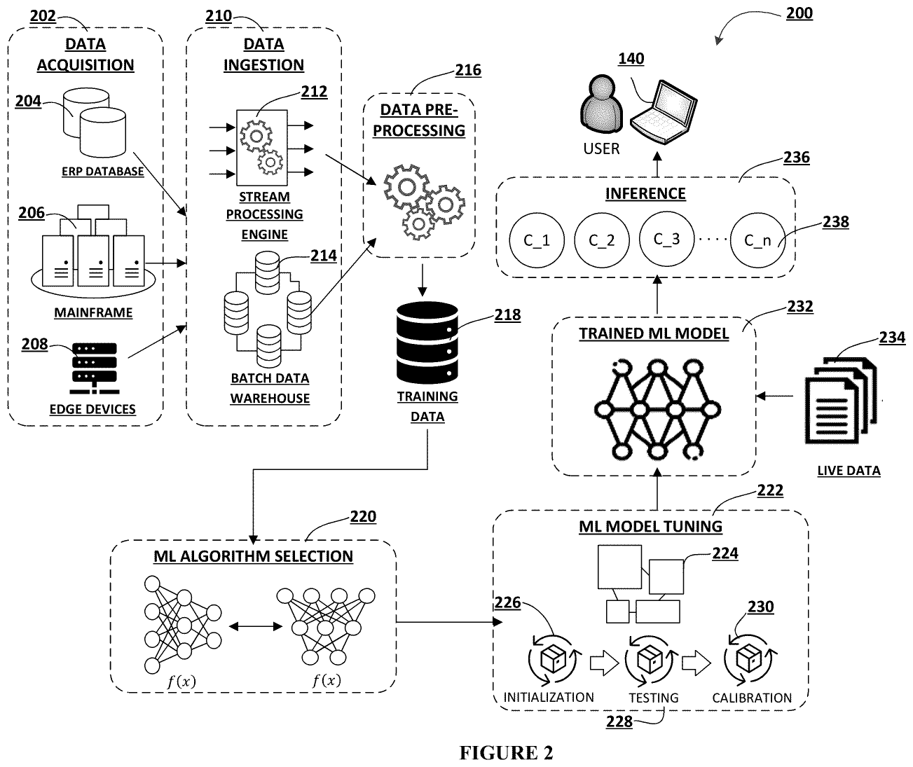

FIG. 2 illustrates an exemplary machine learning (ML) subsystem architecture 200, in accordance with an embodiment of the disclosure. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and /r combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

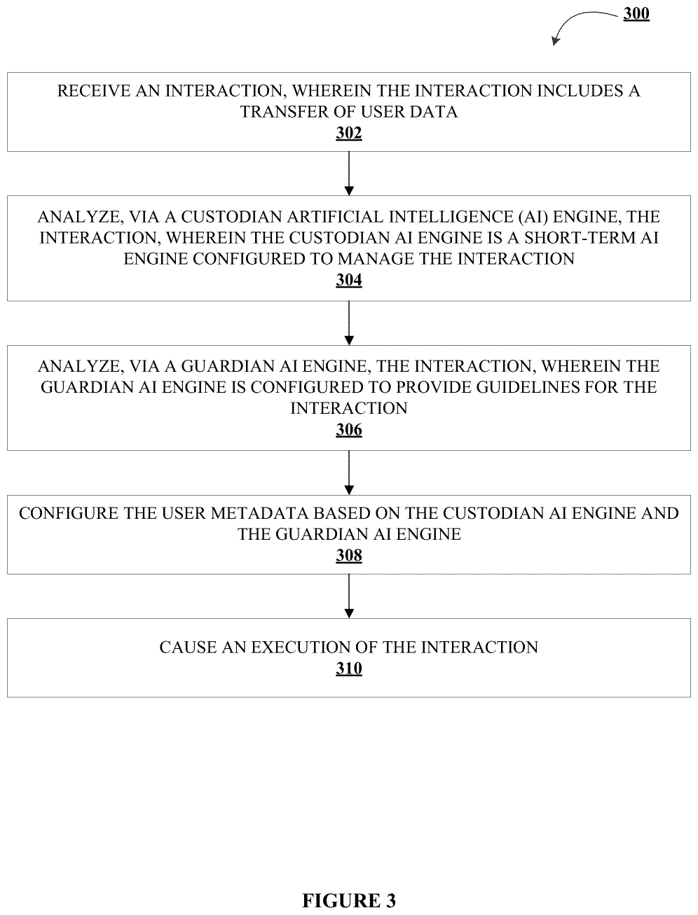

FIG. 3 illustrates a process flow for data access management using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a data access management system (e.g., similar to one or more of the systems described herein with respect to FIGS. 1A-1C) may perform one or more of the steps of process flow 300. For example, a data access management system (e.g., the system 130 described herein with respect to FIGS. 1A-1C) may perform the steps of process flow 300.

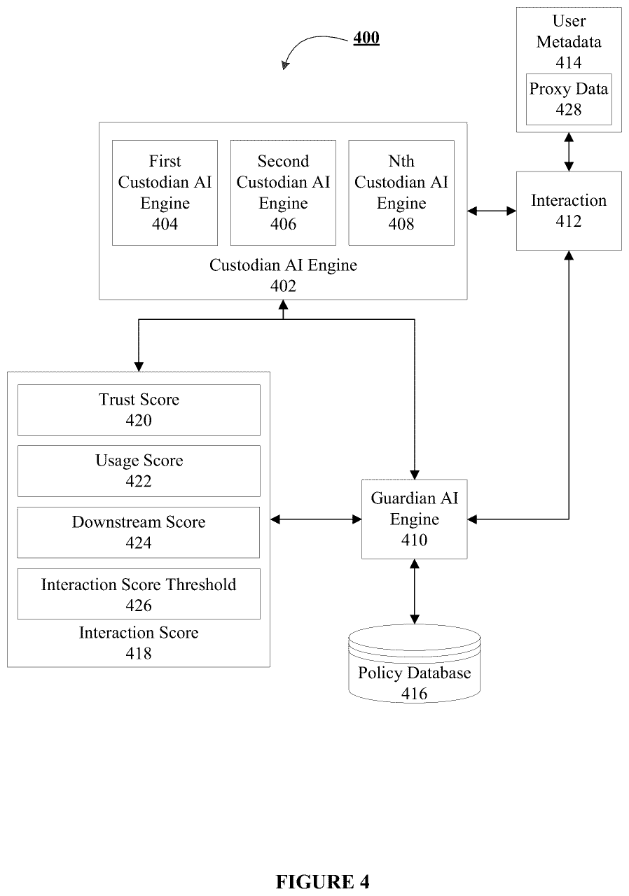

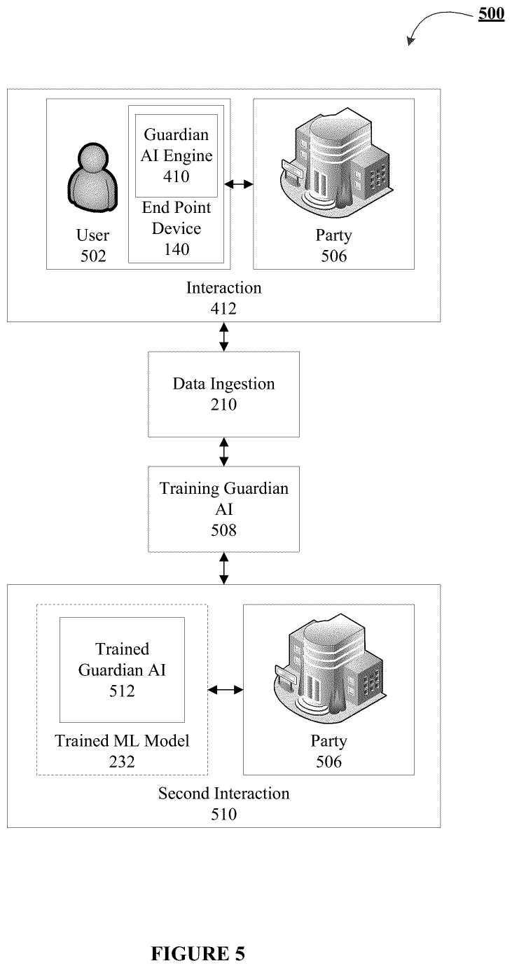

As shown in block 302, the process flow 300 of this embodiment includes receiving an interaction, wherein the interaction includes a transfer of user data. In some embodiments, the interaction may include a transfer of resources. The interaction may include metadata (e.g., user metadata 414 as shown in FIG. 4), transactional data, and resource data. In some embodiments, the transfer of user data may include the transfer of the user metadata 414. For example, the interaction may include an event or the like wherein the user requests goods or services from a party (e.g., the party 506 as shown in FIG. 5). The party may request that the user transfer resources and/or user metadata 414 to complete the interaction.

In some embodiments, the interaction may be initiated by a user associated with the data access management system (e.g., the system 100 as described herein). Further, in some embodiments, the interaction may be initiated by a party (e.g., the party 506) the user is interacting with. Further still, in some embodiments, the interaction may be initiated by the guardian AI engine 410, as shown in FIG. 4.

As shown in block 304, the process flow 300 of this embodiment includes analyzing, via a custodian artificial intelligence (AI) engine, the interaction, wherein the custodian AI engine is a short-term AI engine configured to manage the interaction. In some embodiments, and as shown in FIG. 4, the custodian AI engine 402 may include any number of custodian AI engines. Further, as mentioned above, the custodian AI engine may include a consortium AI engine, which may include a plurality of short-term AI engines. For example, there may be a first custodian AI engine 404, a second custodian AI engine 406, up to an Nth custodian AI engine 408. The custodian AI engine(s) 402 may be configured to help the user while the user navigates the interaction 412. In this way, the custodian AI engine 402 may be spun up, initiated, activated, or the like when the user initiates an interaction 412. The custodian AI engine 402 may be activated when certain conditions (i.e., initiation of an interaction) are met.

In some embodiments, the custodian AI engine managing the interaction includes dynamically configuring an interaction score, wherein the interaction score influences whether the interaction should be executed. Further, in some embodiments, the custodian AI engine 402 may dynamically analyze in real-time a deep level of scoring for the interaction 412 and the associated party (e.g., the party the user is interacting with). In this regard, the custodian AI engine 402, or the associated custodian AI engines (e.g., the first custodian AI engine 404, the second custodian AI engine 406, or the Nth custodian AI engine 408) may have the same or similar components as described in FIG. 2. In this way, the custodian AI engine 402 may include ML models, neural networks, or the like that may be specific to a certain interaction or part of an interaction. Further, the custodian AI engine 402 may be tuned to provide a deep level of scoring that may be used by the guardian AI engine 410 for further analysis on the interaction 412.

Further, the custodian AI engine 402 may use smart contracts to determine how to handle the interaction 412. In this regard, the smart contract may include specific conditions or rules that must be met prior to the interaction 412 completing. For example, a smart contract may indicate a certain level of trust required from a party the user is interacting with before the user's metadata 414 may be transferred to the party. In this example, the custodian AI engine 402 may determine, via the smart contract and analysis of the party, that the interaction 412 may or may not proceed based on the trust level of the party.

As shown in block 306, the process flow 300 of this embodiment includes analyzing, via a guardian AI engine, the interaction, wherein the guardian AI engine is configured to provide guidelines for the interaction. In some embodiments, the guardian AI engine providing guidelines for the interaction includes dynamically configuring an interaction score, wherein the interaction score influences whether the interaction should be executed. In this regard, the custodian AI engine 402 and the guardian AI engine 410 may determine an interaction score 418 associated with the interaction 412. The interaction score 418 may include a trust score 420, a usage score 422, a downstream score 424, and an interaction score threshold 426. In some embodiments, the trust score 420 includes the ability to trust a party associated with the interaction. The trust score 420 may be determined by analyzing the party's historical interactions, community sentiment about the party, complaints against the party, and the like. For example, the guardian AI engine 410 may determine a trust score of a party (e.g., the party 506 as shown in FIG. 5) by researching the party 506 online. In this regard, for instance, the guardian AI engine 410 may read reviews from other users who have interacted with the party 506 in the past, research complaints filed against the party 506, or the like. The guardian AI engine 420 may compile and determine how likely it is that the user 502 may be able to trust the party 506. Further, the trust score 420 may include a numerical value assigned to designate an apparent level of trust held in the party 506.

In some embodiments, the usage score 422 includes the party's proposed use of the user data. The usage score 422 may be determined by analyzing what the party's explicit and implicit intentions are with user data (e.g., the user metadata 414). Doing so may include reading and understanding the reason for the party 506 receiving the user data, which may be found in documents associated with the interaction 412. For example, the party 506 may have terms and conditions associated with the interaction 412 that include provisions associated with the party's 506 intent on distributing, selling, or transferring the user data. Additionally, or alternatively, the guardian AI engine 410 may be able to determine the intended use by asking the party 506. The party's 506 response may be analyzed by the guardian AI engine 410 to determine how the party 506 intends to use the user metadata 414. Further, the usage score 422 may include a numerical value assigned to designate the party's 506 apparent usage of the user data.

In some embodiments, the downstream score 424 includes analyzing third parties associated with the party 506 to determine how the user metadata will be used by the third parties. The party 506 may have other entities associated with it that may receive the user data. These downstream entities may have their own intent to use the user data in a certain way. The party's 506 association with these other entities and the party's 506 ability to limit the entities'ability to further transfer the user data may be analyzed to create the downstream score 424. Further, the downstream score 424 may include a numerical value assigned to designate whether the party 506 further transfers the user data and whether the party 506 can control the user data after transfer. In some embodiments, the interaction score threshold 426 indicates an allowable interaction score of the interaction. In some embodiments, the data access management system may determine the interaction score 418 is outside the interaction score threshold 426.

As shown in block 308, the process flow 300 of this embodiment includes configuring the user metadata based on the custodian AI engine and the guardian AI engine. In this way, the data access management may obfuscate at least a portion of the user metadata 414 prior to transfer during the interaction. In this regard, the guardian AI engine 410 may conceal or obfuscate the user metadata 414 if it is determined that the party's 506 interaction score 418 is low, as compared to the interaction score threshold 426. Further, obfuscating the user data (e.g., the user metadata 414) may include generating proxy data (e.g., proxy data 428) that may be used in place of the user data. In this regard, the guardian AI engine 410 may generate the proxy data 428 that may be transferred to the party 506 during the interaction 412 as opposed to transferring the real user data associated with the user (e.g., the user 502 as shown in FIG. 5). The proxy data 428 may be data that is generated to protect the user metadata 414 and that can be used as a stand-in for the user metadata 414 during interactions 412 where the party 506 requires certain data to be transferred. The proxy data 428 may or may not relate to the user metadata 414 and may be created specifically for the interaction in question. Further, in some embodiments, the proxy data 428 may be re-used in multiple interactions. Further still, the user may be able to dictate to the guardian AI engine 410 the proxy data 428 and may be able to control the creation and subsequent transfer of the proxy data 428. Further, the concealment or obfuscation of the user metadata 414 via the proxy data 428 may include the use of tokenization, pseudonymization, data masking, anonymization, using proxies, synthetic data generation, or the like.

Further, in some embodiments, the data access management system may determine the interaction score 418 is within the interaction score threshold 426. Further, in some embodiments, the data access management system may configure the user metadata 414 prior to transfer during the interaction. The guardian AI engine 410 may configure the user metadata 414 to transfer only the user metadata 414 required to complete the transaction. For example, if a party 506 requests some required user metadata and also requests extraneous user metadata, the guardian AI engine 410 may be able to limit the transfer of the user metadata to only the required user metadata. In this way, the guardian AI engine 410 may not transfer the extraneous user metadata during the interaction 412. Further, the guardian AI engine 410 may generate proxy data 428 that may be used during the interaction 412.

Further, in some embodiments, the data access management system may generate a user persona, wherein the user persona is generated via the user metadata and via historical interactions. Further still, in some embodiments, the data access management system may configure the guardian AI engine based on the user persona, wherein the guardian AI engine is configured in real-time based on the user persona and based on the interaction.

The user persona may include historical interactions that provide the data access management system insights as to how the user prefers to handle interactions. For example, if the user is more conservative in transferring the user's metadata 414, the data access management system and/or the guardian AI engine 410 may learn that the user prefers to withhold information when it is not required to be transferred. The user persona may be used to train the guardian AI engine 410 for interactions in the future that the user may not be a part of. In this way, and in some embodiments, the user may allow the guardian AI engine 410 to unilaterally and independently manage future interactions.

In some embodiments, the guardian AI engine 410 may allow the interaction 412 to proceed even if the guardian AI engine is unsure about the interaction score 418 associated with the interaction 412. In this regard, the party 506 may not reveal its true intentions for the user data, or the guardian AI engine 410 may not be able to find enough information used for determining the trust score 420 of the interaction 412. The interaction 412 may be allowed to proceed, but the guardian AI engine 412 may monitor the interaction 412 until it determines that trusting the party 506 is appropriate. To do so, in some embodiments, the guardian AI engine 410 may generate proxy data 428 to use during the initial stages of the interaction 412. While the interaction 412 proceeds, the guardian AI engine 410 may replace some or all of the proxy data 428 with the real user metadata 414. In this regard, the party 506 may gain the trust of the guardian AI engine 410 and the guardian AI engine 410 may determine it appropriate to supplant the proxy data 428 with the user metadata 414.

In some embodiments, the data access management system may analyze a policy database, wherein the policy database includes rules associated with the interaction. In some embodiments, the data access management system may configure the guardian AI engine based on the policy database. In this regard, the guardian AI engine 410 may receive policies from a policy database 416. The policy database 416 may include rules, regulations, laws, provisions, or the like that may be used to determine whether an interaction 412 should proceed. In this regard, the guardian AI engine 410 may actively search the policy database 416 or may be transferred a policy database 416 during an interaction 412. For example, the policy database 416 may contain regulations governing the interaction 412, which may be analyzed by the guardian AI engine 410 while the interaction is unfolding.

The guardian AI engine 410 may analyze all of the inputs, including those from the policy database 416, to determine whether the interaction 412 should proceed. For example, the guardian AI engine 410 may receive the inputs from the custodian AI engine 402, the interaction score 418, and the policy database 416. The guardian AI engine 410 may weigh each of the inputs to determine whether the user metadata 414 and/or resources should be transferred during the interaction 412, whether to use proxy data 428, or whether to stop the interaction 412. Further, the guardian AI engine 410 may dynamically and in real-time assign weights to each of these inputs based on the interaction 412 and the source of the input. For example, if a policy from the policy database 416 indicates the interaction 412 would be illegal if completed, the guardian AI engine 410 may place an appropriate amount of weight to stop the interaction 412 despite the custodian AI engine 402 being in favor of the interaction 412 proceeding.

As shown in block 310, the process flow 300 of this embodiment includes causing an execution of the interaction. Upon a determination that the interaction 412 should proceed (e.g., the execution of the interaction), the custodian AI engine 402 may handle the user metadata 414 or resource transfer. In this regard, the custodian AI engine 402 may transfer the correct amount of resources, if required, and ensure secure and safe transfer of the user metadata 414. To do this, in some embodiments, the custodian AI engine 402 may tokenize the resources or the user metadata 414. The tokenization process may convert the sensitive data (e.g., the resources, the user metadata 414, or the like) into a secure format that prevents unauthorized access or tampering.

The interaction 412 may include a transfer of resources or a transfer of user metadata 414. The user metadata 414 may include sensitive information of the user, such as personal information, that may need to be secured prior to being transferred during the interaction 412. The party the user is interacting with during the interaction 412 may require certain user metadata 414 may need to be transferred to complete the interaction 412.

In some embodiments, the guardian AI engine 410 may include a portable AI engine that a user may use during interactions (e.g., such as the interaction 412) to assist the user in navigating through the interaction. For example, and as shown in FIG. 5, a user 502 may have an interaction 412 with a party 506. The user 502 may use a user device (e.g., the end-point device 140 as shown in FIG. 1C) that has the guardian AI engine 410 loaded onto it (e.g., the portable AI engine). In this way, the guardian AI engine 410 may be stored on the end-point device's 140 memory 154, or the like. Further, in some embodiments, the portable version of the guardian AI engine 410 may be stored on a database that may be accessed via the network 110 by the end-point device 140 or the user device.

The interaction 412 may include a variety of interactions that may require the user 502 to transfer resources or metadata (e.g., user metadata 414) to the party 506. For example, the user 502 may be required to transfer the user's metadata or other information to the party 506 to complete the interaction 412. The guardian AI engine 410 may be analyzing the interaction 412 as it is proceeding to understand the user's 502 tendencies during the interaction, the party's 506 tendencies during the interaction, or the like. For example, if the user 502 tends to obfuscate the user's 502 own data prior to transmitting it to the party 506, the guardian AI engine 410 may learn and understand that for future interactions.

In some embodiments, the interaction 412 may be ingested for training the guardian AI 410. In this regard, the data ingestion 210 may be the same or similar to the data ingestion 210 as described in FIG. 2. In some embodiments, all interactions the user 502 performs where the guardian AI engine 410 is used may be used for training the guardian AI engine 508. In this regard, the guardian AI engine 410 may then be updated to understand how the user 502 operates and navigates during differing interaction types. Eventually, and in some embodiments, when the guardian AI engine is trained enough to fully understand and predict how the user 502 will navigate through a particular interaction, the trained guardian AI engine 512 may be used during a second interaction 510. In this regard, the trained guardian AI engine 512 may be able to handle interactions rather than the user 502 having to handle the interaction. As shown in FIG. 5, the trained ML model 232 may include the trained guardian AI engine 512. In this regard, the trained guardian AI engine 512 may interact with the party 506 during a second interaction 510.

Further, in some embodiments, the guardian AI engine 410 may be paired with a digital ledger configured to require a certain number of current users and the guardian AI engine 410 to approve an action before allowing the action to proceed. In this regard, the action (e.g., an interaction) may be received and processed by the data access management system. For example, users associated with the interaction may be able to provide input as to whether the interaction should proceed. Further, in this example, the guardian AI engine may also be able to provide input on whether the interaction should proceed. In some embodiments, the input may be sent to and stored in a digital ledger, that may be used to determine whether the interaction should proceed.

Additionally, and in some embodiments, the guardian AI engine 410 may be continually trained by a feedback loop of the current user(s) and their actions, interactions, effects of the actions and interactions, and the like. In this way, the guardian AI engine 410 may iteratively train and/or retrain itself based on current conditions and data points, while maintaining historical guardrails. The historical guardrails, for example, may be determined based on the historical interactions and the user persona. Further, in some embodiments, the guardian AI engine 410 may include a documentation engine, wherein the documentation engine is configured to document each action (e.g., during the interactions), the effects of each action, and other such data to generate a timeline of each event/interaction and each event/interaction's surrounding data. In this regard, the documentation engine may be used by guardian AI engine 410 to create the historical guardrails used during the decision making of the guardian AI engine 410.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for data access management using advanced computational models for data analysis and automated processing, the system comprising:
a processing device;
a non-transitory storage device containing instructions when executed by the processing device, causes the processing device to perform the steps of:
receive an interaction, wherein the interaction comprises a transfer of user metadata;
analyze, via a custodian artificial intelligence (AI) engine, the interaction, wherein the custodian AI engine is a short-term AI engine configured to manage the interaction;
analyze, via a guardian AI engine, the interaction, wherein the guardian AI engine is configured to provide guidelines for the interaction;
configure the user metadata based on the custodian AI engine and the guardian AI engine; and
cause an execution of the interaction.

2. The system of claim 1, wherein executing the instructions further causes the processing device to:
generate a user persona, wherein the user persona is generated via the user metadata and via historical interactions, and
configure the guardian AI engine based on the user persona, wherein the guardian AI engine is configured in real-time based on the user persona and based on the interaction.

3. The system of claim 1, wherein the custodian AI engine managing the interaction comprises dynamically configuring an interaction score, wherein the interaction score influences whether the interaction should be executed.

4. The system of claim 1, wherein the guardian AI engine providing guidelines for the interaction comprises dynamically configuring an interaction score, wherein the interaction score influences whether the interaction should be executed.

5. The system of claim 4, wherein the interaction score comprises:
a trust score, wherein the trust score comprises the ability to trust a party associated with the interaction;
a usage score, wherein the usage score comprises the party's proposed use of the user metadata; and
a downstream score, wherein the downstream score comprises analyzing third parties associated with the party to determine how the user metadata will be used by the third parties.

6. The system of claim 5, wherein executing the instructions further causes the processing device to:
determine an interaction score threshold, wherein the interaction score threshold indicates an allowable interaction score of the interaction;
determine the interaction score is within the interaction score threshold; and
configure the user metadata prior to transfer during the interaction.

7. The system of claim 5, wherein executing the instructions further causes the processing device to:
determine an interaction score threshold, wherein the interaction score threshold indicates an allowable interaction score of the interaction;
determine the interaction score is outside the interaction score threshold; and
obfuscate at least a portion of the user metadata prior to transfer during the interaction.

8. The system of claim 1, wherein executing the instructions further causes the processing device to:
analyze a policy database, wherein the policy database comprises rules associated with the interaction; and
configure the guardian AI engine based on the policy database.

9. A computer program product for data access management using advanced computational models for data analysis and automated processing, the computer program product comprising a non-transitory computer-readable medium comprising code causing an apparatus to:
receive an interaction, wherein the interaction comprises a transfer of user metadata;
analyze, via a custodian artificial intelligence (AI) engine, the interaction, wherein the custodian AI engine is a short-term AI engine configured to manage the interaction;
analyze, via a guardian AI engine, the interaction, wherein the guardian AI engine is configured to provide guidelines for the interaction;
configure the user metadata based on the custodian AI engine and the guardian AI engine; and
cause an execution of the interaction.

10. The computer program product of claim 9, wherein the code further causes the apparatus to:
generate a user persona, wherein the user persona is generated via the user metadata and via historical interactions, and
configure the guardian AI engine based on the user persona, wherein the guardian AI engine is configured in real-time based on the user persona and based on the interaction.

11. The computer program product of claim 9, wherein the custodian AI engine managing the interaction comprises dynamically configuring an interaction score, wherein the interaction score influences whether the interaction should be executed.

12. The computer program product of claim 9, wherein the guardian AI engine providing guidelines for the interaction comprises dynamically configuring an interaction score, wherein the interaction score influences whether the interaction should be executed.

13. The computer program product of claim 12, wherein the interaction score comprises:
a trust score, wherein the trust score comprises the ability to trust a party associated with the interaction;
a usage score, wherein the usage score comprises the party's proposed use of the user metadata; and
a downstream score, wherein the downstream score comprises analyzing third parties associated with the party to determine how the user metadata will be used by the third parties.

14. The computer program product of claim 13, wherein the code further causes the apparatus to:
determine an interaction score threshold, wherein the interaction score threshold indicates an allowable interaction score of the interaction;
determine the interaction score is within the interaction score threshold; and
configure the user metadata prior to transfer during the interaction.

15. The computer program product of claim 13, wherein the code further causes the apparatus to:
determine an interaction score threshold, wherein the interaction score threshold indicates an allowable interaction score of the interaction;
determine the interaction score is outside the interaction score threshold; and
obfuscate at least a portion of the user metadata prior to transfer during the interaction.

16. The computer program product of claim 9, wherein the code further causes the apparatus to:
analyze a policy database, wherein the policy database comprises rules associated with the interaction; and
configure the guardian AI engine based on the policy database.

17. A method for data access management using advanced computational models for data analysis and automated processing, the method comprising:
receiving an interaction, wherein the interaction comprises a transfer of user metadata;
analyzing, via a custodian artificial intelligence (AI) engine, the interaction, wherein the custodian AI engine is a short-term AI engine configured to manage the interaction;
analyzing, via a guardian AI engine, the interaction, wherein the guardian AI engine is configured to provide guidelines for the interaction;
configuring the user metadata based on the custodian AI engine and the guardian AI engine; and
causing an execution of the interaction.

18. The method of claim 17, wherein the method further comprises:
generating a user persona, wherein the user persona is generated via the user metadata and via historical interactions, and
configuring the guardian AI engine based on the user persona, wherein the guardian AI engine is configured in real-time based on the user persona and based on the interaction.

19. The method of claim 17, wherein the custodian AI engine managing the interaction comprises dynamically configuring an interaction score, wherein the interaction score influences whether the interaction should be executed.

20. The method of claim 17, wherein the guardian AI engine providing guidelines for the interaction comprises dynamically configuring an interaction score, wherein the interaction score influences whether the interaction should be executed.
